(19) United States
(12) Patent Application Publication
(10) Pub. No.: US 2018/0376277 A1
(43) Pub. Date: Dec. 27, 2018

(54) TRANSACTION TERMINAL AND SYSTEM FOR OBTAINING THIRD-PARTY LOCATON BASED SERVICES AND METHOD THEREOF

(71) Applicant: Mastercard International Incorporated, Purchase, NY (US)

(72) Inventors: Hufriya Dudhmahl, Mumbai (IN); Mayank Prakash, Haryana (IN); Akshay Kumar, Jharkhand (IN)

(21) Appl. No.: 15/972,542

(22) Filed: May 7, 2018

(30) Foreign Application Priority Data
Jun. 23, 2017 (SG) 10201705259V

(51) Int. Cl. H04W 4/02; H04W 12/06; H04L 29/06

(52) U.S. Cl. CPC H04W 4/02; H04L 63/08; H04W 12/06

(57) ABSTRACT

A system, method, and transaction terminal for obtaining location based services provided by third-party service providers through a transaction terminal is disclosed. The method includes authenticating a user based on user identification information received at the transaction terminal. Upon authentication, the method further includes receiving a user request, through the transaction terminal, for a location based service provided by a third-party service provider. The method further includes authorizing the third-party service provider to provide the location based service to the user based on the user identification information and the location of the transaction terminal.

### CROSS-REFERENCE TO RELATED APPLICATION

This application is a U.S. National Stage filing under 35 U.S.C. § 119, based on and claiming benefits of and priority to Singapore Patent Application No. 10201705259V filed on Jun. 23, 2017. The entire disclosure of the above application is incorporated herein by reference.

### TECHNICAL FIELD

The present invention relates to providing location based services, and in particular, to system and method for obtaining location based services provided by third-party service providers through a transaction terminal.

### BACKGROUND

With the growth of smart mobile devices and mobile communication technologies, location based services has become ubiquitous. Such services typically provide information, entertainment, security, convenience, or other features based on real-time location data retrieved from a user's smart mobile device. For example, a user may hail a cab at the user's current or future location using a mobile application, such as UBER®, or book a ticket for an event in the vicinity of the user's current or future location using another mobile application, and so forth.

However, many a times, the user may not be able to request location based services because the user's smart mobile device is unavailable (e.g., user not possessing the device, drained-out device battery, damaged or unresponsive device, etc.) or because associated applications are non-functional (e.g., due to non-existent or limited data connection, etc.). Further, there may be situations in which such user may need to request location based services for reasons of safety, convenience, emergencies, and so forth.

### SUMMARY

In one embodiment, a method for obtaining location based services provided by third-party service providers through a transaction terminal, is disclosed. The method includes authenticating a user based on user identification information received at the transaction terminal. Upon authentication, the method further includes receiving a user request, through the transaction terminal, for a location based service provided by a third-party service provider. The method further includes authorizing the third-party service provider to provide the location based service to the user based on the user identification information and the location of the transaction terminal.

In another embodiment, a system for obtaining location based services provided by third-party service providers through a transaction terminal, is disclosed. The system includes at least one processor based computing device and a memory communicatively coupled to the at least one processor based computing device. The memory stores processor-executable instructions, which, on execution, causes the processor based computing device to authenticate a user based on user identification information received at the transaction terminal. Upon authentication, the processor-executable instructions, on execution, further cause the processor based computing device to receive a user request, through the transaction terminal, for a location based service provided by a third-party service provider. The processor-executable instructions, on execution, further cause the processor based computing device to authorize the third-party service provider to provide the location based service to the user based on the user identification information and the location of the transaction terminal.

In a further embodiment, a transaction terminal is disclosed. The transaction terminal includes an input device, an output device, a network device, and at least one processor. The at least one processor executes instructions to receive, through the input device, user identification information from a user. The at least one processor further executes instructions to receive, through the network device, a list of available location based services and associated one or more third-party service providers based on the user identification information and the location of the transaction terminal. The at least one processor further executes instructions to render, through the output device, to the user the list of available location based services and the associated one or more third-party service providers. The at least one processor further executes instructions to receive, through the input device, a user request for a location based service provided by a third-party service provider from among the list of available location based services and the associated one or more third-party service providers. The at least one processor further executes instructions to receive, through the network device, service details for the location based service based on the user request. The at least one processor further executes instructions to render, through the output device, the service details to the user for availing the location based service.

In a yet another embodiment, a portable transaction device is disclosed. The portable transaction device includes a computer-readable medium adapted to store at least encoded user identification information, and encoded service details of a location based service provided by a third-party service provider.

In a further embodiment, a non-transitory computer-readable storage medium having stored thereon, a set of computer-executable instructions for obtaining location based services provided by third-party service providers through a transaction terminal, is disclosed. The set of computer-executable instructions cause a computer comprising one or more processors to authenticate a user based on user identification information received at a transaction terminal. Upon authentication, the set of computer-executable instructions further cause a computer comprising one or more processors to receive a user request, through the transaction terminal, for a location based service provided by a third-party service provider. The set of computer-executable instructions further cause a computer comprising one or more processors to authorize the third-party service provider to provide the location based service to the user based on the user identification information and the location of the transaction terminal.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a schematic architecture of an exemplary system for obtaining location based services provided by third-party service providers through a transaction terminal, in accordance with some embodiments.

FIG. 2 illustrates various communication scenarios between entities of the exemplary system for facilitating booking of location based services provided by third-party service providers through the transaction terminal, in accordance with some embodiments.

FIG. 3 is a functional block diagram of the exemplary system for obtaining location based services provided by third-party service providers through the transaction terminal, in accordance with some embodiments.

FIG. 4 is a flow diagram of an exemplary process for obtaining location based services provided by third-party service providers through the transaction terminal, in accordance with some embodiments.

FIG. 5 is a flow diagram of another exemplary process for obtaining location based services provided by third-party service providers through the transaction terminal, in accordance with some embodiments.

FIG. 6 is a flow diagram of an exemplary registration process for availing location based cab booking service from a third-party service provider through the transaction terminal, in accordance with some embodiments.

FIG. 7 illustrates an exemplary information flow between various entities during a cab booking process through the transaction terminal, in accordance with some embodiments.

FIG. 8 illustrates another exemplary information flow between various entities during a cab booking process through the transaction terminal, in accordance with some embodiments.

FIG. 9 illustrates an exemplary cab booking process through the transaction terminal, in accordance with some embodiments.

FIG. 10 illustrates an exemplary payment processing for location based cab service availed by the user through the transaction terminal, in accordance with some embodiments.

FIG. 11 illustrates a block diagram of an exemplary computer system for implementing various embodiments.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

The disclosed embodiments relate to a technique for obtaining location based services provided by third-party service providers through a transaction terminal. The disclosed embodiments describe transaction terminal booking mechanisms, devices, and systems, computerized logic to operate the mechanisms, devices, and systems, and methods of operation thereof. In the embodiments, the transaction terminal as well as the overall system may include modules that enable a user to obtain a location based service provided by a third-party service provider, via the transaction terminal. Some of the disclosed embodiments relate to transaction terminal booking mechanisms for obtaining a cab service. However, various disclosed methods, devices, and systems for transaction terminal booking mechanisms are intended to be usable with any type of location based services provided by one or more third-party service providers (e.g., movie tickets, restaurant reservations, vehicle breakdown services, sharing location details, etc.) for user's convenience, safety, and emergencies.

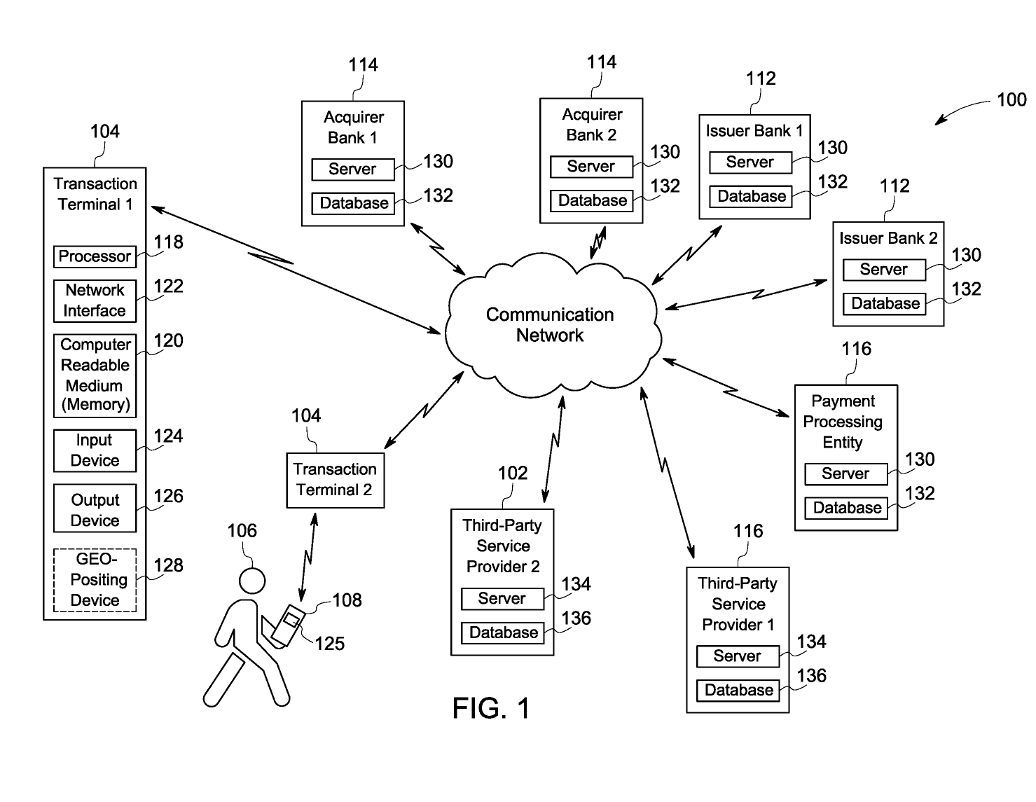

Referring now to FIG. 1, a schematic architecture of an exemplary system 100 for obtaining location based services provided by third-party service providers 102 through a transaction terminal 104, is illustrated in accordance with some embodiments. A representative user 106 interacts with the transaction terminal 104 either directly (e.g., using identification information, biometric information, etc.) or through a portable transaction device 108 (e.g., contact or contactless transaction card, contact or contactless smart card, RFID card, transaction token, payment card, etc.). The transaction terminal 104 further interacts over a wired or a wireless communication network 110 (e.g., cellular network via cell tower, broadband network such as Internet, wireless network via access point) with one or more third party service providers 102 providing various location based services either directly or through one or more transaction authentication, processing, and authorizing entities 112, 114, 116.

The transaction terminal 104 may be an Automated Teller Machine (ATM) or a payment terminal (e.g., a fixed Point of Sale (PoS) terminal, a mobile PoS terminal, etc.). The transaction terminal 104 may include a processor 118 for processing data and instructions for the transaction terminal 104, for coordinating with various other components of the transaction terminal 104, and so forth. The transaction terminal 104 may further include a computer readable storage medium 120 for storing data and instructions for processing by the processor. The transaction terminal 104 may further include a network device 122 (e.g., transceiver, network interface, etc.) for facilitating communication over the communication network 110. The network device 122 may facilitate the transaction terminal 104 to send data to and receive data from one or more transaction authentication, processing, and authorizing entities 112, 114, 116. For example, the transaction terminal 104 may send identification information and user request, while receive list of available location based services associated service providers, and service details.

The transaction terminal 104 may further include an input device 124 (e.g., keypad, touch screen, touchpad, microphone, mouse, stylus, card reader, portable transaction device reader, dongle reader, biometric reader, etc.) for receiving user identification information, user input, user request, and so forth. For example, in some embodiments, the user may directly input his authentication credentials (e.g., user id, and password) as well as other user request or inputs through the keypad or the touch screen. Alternatively, in some embodiments, the user may provide voice based authentication (user id, password) and user request or inputs through the microphone. Further, in some embodiments, the user may provide biometric authentication (finger print, retina etc.) through the biometric reader. Alternatively, in some embodiments, the user may provide identification information using the portable transaction device 108 (e.g., transaction card, smart card, RFID card, transaction token, payment card, etc.) through the portable transaction device reader (e.g., card reader, RFID reader, or token reader, etc.). In some embodiments, the portable transaction device 108 may include a computer-readable medium 125 (e.g., memory) adapted to store encoded user identification information.

The transaction terminal 104 may further include an output device 126 (e.g., display, audio speaker, portable transaction device writer, card writer, printer, etc.) for rendering user interface, list of location based services and associated third-party service providers, receipt of service details, and so forth. For example, in some embodiments, the transaction terminal 104 may present the user interface, the list of location based services and the associated third-party service providers, and the service details of the booked location based service through the display device. Alternatively, in some embodiments, the transaction terminal 104 may provide the list of location based services and the associated third-party service providers, and the service details through the speaker. Further, in some embodiments, the transaction terminal 104 may print the service details in a receipt through the printer. Alternatively, in some embodiments, the transaction terminal 104 may encode the service details in the portable transaction device 108 (e.g., transaction card, transaction token, payment card, etc.) through the portable transaction device writer (e.g., card writer, dongle writer). In such embodiment, the computer-readable medium of the portable transaction device 108 is further adapted to store encoded service details of the booked location based service. The encoded service details may be eventually employed to authorize fulfillment of the location based service availed by the user.

In some embodiments, the transaction terminal 104 is pre-mapped to a definite location. The location details of the transaction terminal may be employed by the third-party service providers to provide the location based services to the user. Alternatively, in some embodiments, the transaction terminal 104 may include a geo-positioning device 128 for determining the location of the transaction terminal, which may then be provided to the third-party service providers. Alternatively, in some embodiments, the location of the transaction terminal 104 may be determined by triangulating the signals received by the transceiver from a number of cell tower in the vicinity of the transaction terminal 104. As will be appreciated, such technique of determining location of the transaction terminal 104 may be employed when the transaction terminal is mobile (e.g., mobile PoS terminal) or is otherwise not pre-mapped to a definite location.

The one or more transaction authentication, processing, and authorizing entities may include, but are not limited to, a bank 112 having user account (e.g., bank 1 that issued transaction card to the user or issuer bank), a bank 114 that acquires user identification information (e.g., bank 2 that owns the transaction terminal or acquirer bank), and an intermediary payment processing entity 116 (e.g., MASTERCARD®) that processes transactions between the two banks (i.e., issuer bank and acquirer bank) or between the bank (i.e., issuer bank or acquirer bank) and the one or more third-party service providers 102. Each of the one or more transaction authentication, processing, and authorizing entities 112, 114, 116 may include a server 130 and a database 132, and may be in communication with each other or the one or more third party service providers 102 over the communication network 110. The database 132 may include database of bank users, database of users registered for the location based services, database of location based services and associated third-party service providers, database of booked services, and so forth. Similarly, the third-party service provider may include a server 134 and a database 136, and may be in communication with the transaction terminal 104 or the one or more transaction authentication, processing, and authorizing entities 112, 114, 116 over the communication network 110. The database 136 may include the database of service personnel along with their static or dynamic location details, database of registered users, database of booked services, and so forth.

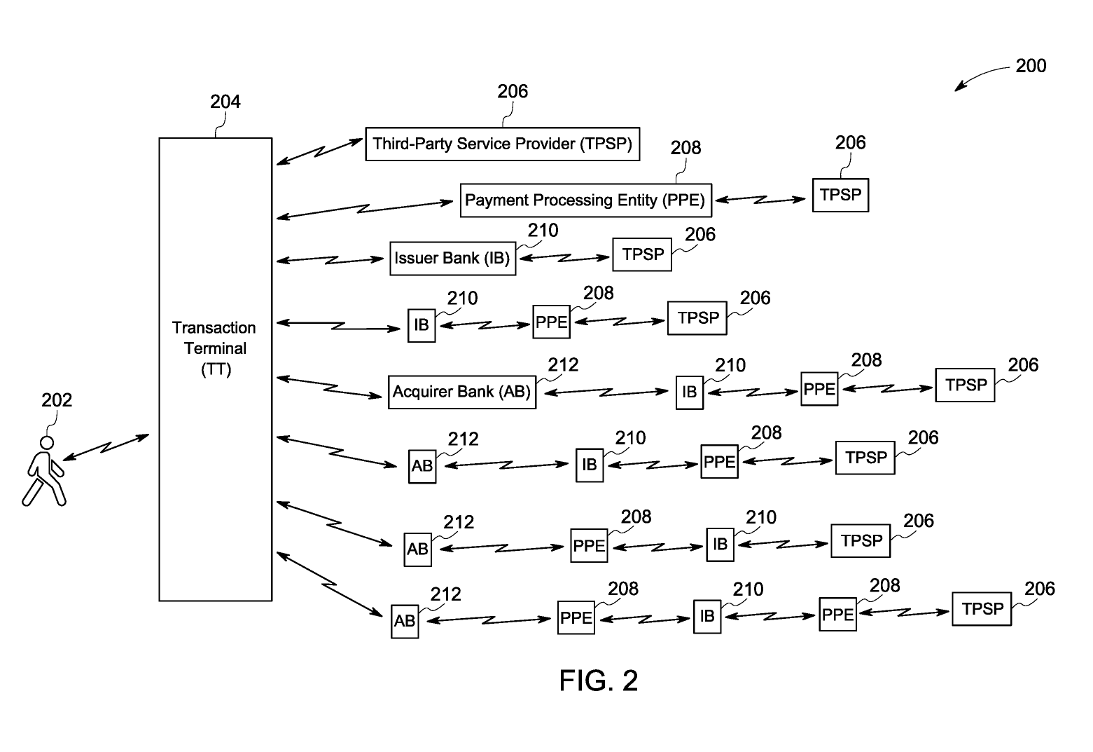

Referring now to FIG. 2, various communication scenarios between two or more entities of the exemplary system 100 of FIG. 1 for facilitating booking of location based services provided by third-party service providers through a transaction terminal, are illustrated in accordance with some embodiments. As illustrated, a user 202 interacts with the transaction terminal 204, which in turn interacts with third-party service providers 206 either directly, or through one or more entities. For example, the transaction terminal 204 may directly communicate with a third-party service provider 206 so as to facilitate booking of location based services. Alternatively, the transaction terminal 204 may communicate with the third-party service provider 206 through an intermediary payment processing entity 208. Further, the transaction terminal 204 may communicate with the third-party service provider 206 through an issuer bank 210. Alternatively, the transaction terminal 204 may communicate with the third-party service provider 206 through the issuer bank 210 and the intermediary payment processing entity 208. In such case, the communication between the issuer bank 210 and the third-party service provider 206 may be managed by the intermediary payment processing entity 208.

Further, the transaction terminal 204 may communicate with the third-party service provider 206 through an acquirer bank 212 and the issuer bank 210. Additionally, the transaction terminal 204 may communicate with the third-party service provider 206 through the acquirer bank 212, the issuer bank 210, and the intermediary payment processing entity 208. For example, the communication between the acquirer bank 212 and the issuer bank 210 may be direct, while the communication between the issuer bank 210 and the third-party service provider 206 may be managed by the intermediary payment processing entity 208. Alternatively, the communication between the acquirer bank 212 and the issuer bank 210 may be managed by the intermediary payment processing entity 208, while the communication between the issuer bank 210 and the third-party service provider 206 may be direct. Alternatively, the communication between the acquirer bank 212 and the issuer bank 210 as well as the communication between the issuer bank 210 and the third-party service provider 206 may be managed by the intermediary payment processing entity 208. As will be appreciated, various other communication scenarios, may be possible between the transaction terminal 204 and the third-party service provider 206 while involving one or more of the intermediary payment processing entity 208, the issuer bank 210, and the acquirer bank 212.

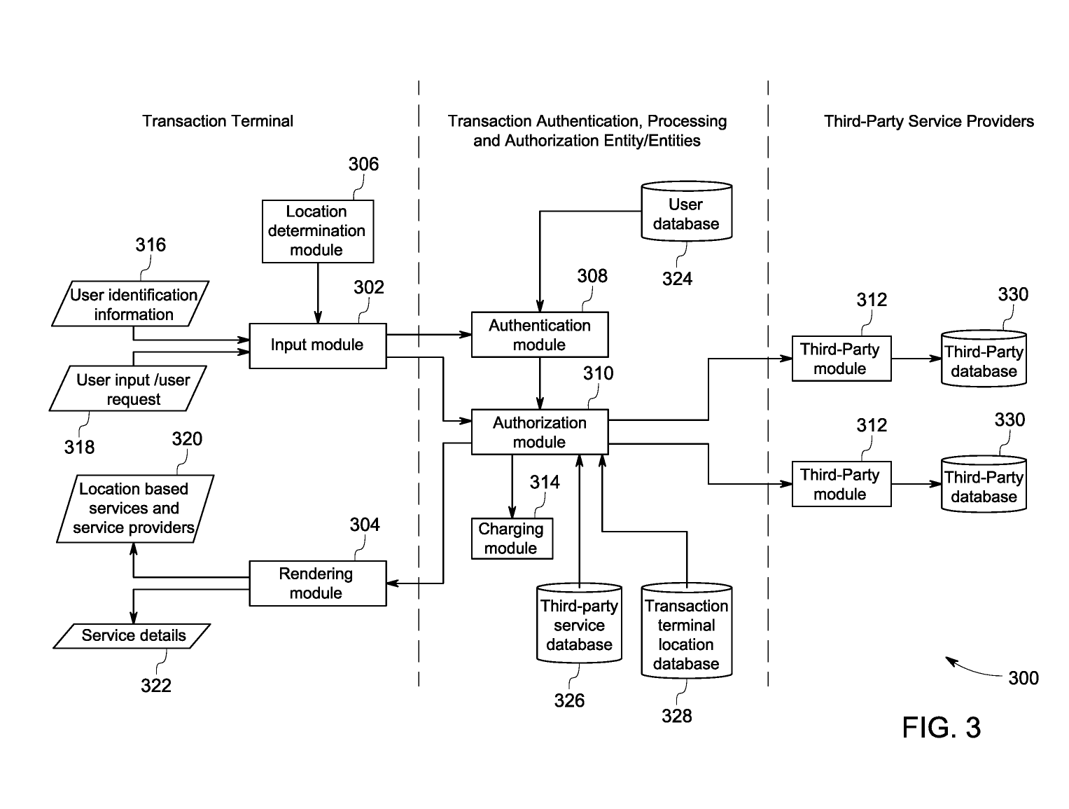

Referring now to FIG. 3, a functional block diagram of the exemplary system 100 of FIG. 1 for obtaining location based services provided by third-party service providers through a transaction terminal, is illustrated in accordance with some embodiments. As illustrated, the system 300 (analogous to system 100 of FIG. 1) includes an input module 302, a rendering module 304, and an optional location determination module 306 as part of each of the transaction terminals. The system 300 further includes an authentication module 308, an authorization module 310, and a charging module 314 as part of one or more transaction authentication, processing, and authorizing entities. The system 300 further includes a third party module 312 as part of each of the third-party service providers.

The input module 302 receives identification information 316 from the user, as well as any user input or request 318 with respect to the location based service through one or more input devices. In some embodiments, the input module 302 also receives location details from the location determination module 306. The input module 302 provides the authentication details to the authentication module 308. The input module 302 further provides the user input or request 318 with respect to the location based service as well as location details of the transaction terminal to the authorization module 310. The rendering module 304 receives the list of location based services and associated third-party service providers 320, as well as the service details 322 from the authorization module 310, and renders the same to the user through one or more output devices. In some embodiments, the location determination module 306 determines the location of the transaction terminal using the geo-positioning device or using triangulation and provides the same to the input device 302.

The authentication module 308 receives the identification information 316 from the input module 302, and authenticates the user based on the identification information 316. The authentication module 308 employs a user database 324 to authenticate the user by comparing the received identification information 316 with that in the user database 324. Upon authentication, the authentication module 308 provides the identification details and status of authentication to the authorization module 310.

The authorization module 310 facilitates the booking of the location based service by the user. Upon positive authentication of the user by the authentication module 308, the authorization module 310 determines a list of available location based services and associated third-party service providers 320, and provides the same to the rendering module 304 for rendering to the user. The authorization module 310 employs a third-party service database 326 to determine the list of available location based services and associated third-party service providers 320 based on the location of the transaction terminal. As will be appreciated, the authorization module 310 receives the location details of the transaction terminal from the input module 302. Alternatively, the authorization module 310 employs a transaction terminal location database 328 to determine the location of the transaction terminal through which the user is interacting based on a unique identification of the transaction terminal. Additionally, in some embodiments, the authorization module 310 determines if the user is registered for one or more of the available location based services, and upon positive determination, provides the one or more of the available location based services and associated third-party service providers 320 to the rendering module 304 for rendering to the user.

The authorization module 310 further receives the user input or request 318 with respect to a location based service from among the rendered one or more of the available location based services 320 from the input module 302. The authorization module 310 further coordinates with the third-party module 312 of the associated service provider to determine the service details 322, and provides the same 322 to the rendering module 304 for rendering to the user. Additionally, in some embodiments, the authorization module 310 provides the service details 322 to the charging module 314 for charging a user account associated with the user for availing the location based service.

The third-party module 312 at an associated third-party service provider receives user request 318 for the location based service from the authorization module 310, and determines the service details 322 for the requested location based service. In some embodiments, the service details includes, but are not limited to, a service identification code, a service authorization code, a service delivery schedule, and a service delivery personnel identification. The third-party module 312 employs a third-party database 330 to determine the service details 322 according to their operational methodologies. For example, if a user has requested for a cab from UBER®, the third party module 312 at UBER® may determine a cab closest to the user based on the location of the transaction terminal at which the user is making the request. The third-party module 312 may then provide the service details 322 to the authorization module 310 for subsequent rendering to the user via the rendering module 304. In some embodiments, the third-party module 312 receives user identification along with the user request 318, particularly when the user has registered for the location based service provided by the associated third-party service provider.

The charging module 314 charges the user account associated with the user for availing the location based service. In some embodiments, the charging module 314 determines the line of credit extended to the user based on the user account or available funds in the user account, and charges accordingly for the location based service. If the user has insufficient balance in the account or insufficient line of credit, then the charging module 314 provides the detail to the authorization module 310 which may then not authorize the request for the location based service. It should be noted that the charging may be performed prior to availing of the service or after availing of the service, based on policies of the transaction authentication, processing, and authorizing entity or the third-party service providers.

It should be noted that, the authentication module 308, the authorization module 310, the third-party module 312, and the charging module 314 along with their respective databases may reside together or separately in any of the one or more transaction authentication, processing, and authorizing entities and the third-party service providers. For example, the authentication module 308 and the user database 324 may reside in the issuer bank server and database, the authorization module 310, the charging module 314, the third-party service database 326, and the transaction terminal location database 328 may reside in the intermediary payment processing entity server and database, and the third-party module 312 and the third-party database 330 may reside in the third-party server and database. Alternatively, the authentication module 308, the authorization module 310, the charging module 314, the user database 324, the third-party service database 326, and the transaction terminal location database 328 may reside in the intermediary payment processing entity server and database, while the third-party module 312 and the third-party database 330 may reside in third-party server and database.

Further, it should be noted that above discussed system, subsystems, environments, components, entities, engines, modules, etc. for obtaining location based services through the transaction terminal may be implemented in programmable hardware devices such as programmable gate arrays, programmable array logic, programmable logic devices, and so forth. Alternatively, the system, subsystems, environments, components, entities, engines, modules, etc. may be implemented in software for execution by various types of processors. An identified engine of executable code may, for instance, include one or more physical or logical blocks of computer instructions which may, for instance, be organized as an object, procedure, function, module, or other construct. Nevertheless, the executables of an identified engine need not be physically located together, but may include disparate instructions stored in different locations which, when joined logically together, include the engine and achieve the stated purpose of the engine. Indeed, an engine of executable code could be a single instruction, or many instructions, and may even be distributed over several different code segments, among different applications, and across several memory devices.

As will be appreciated by one skilled in the art, a variety of processes may be employed for for obtaining location based services provided by third-party service providers through the transaction terminal. For example, the exemplary system 100 may facilitate booking of location based services provided by third-party service providers through the transaction terminal by the processes discussed herein. In particular, as will be appreciated by those of ordinary skill in the art, control logic and/or automated routines for performing the techniques and steps described herein may be implemented by the exemplary system 100, either by hardware, software, or combinations of hardware and software. For example, suitable code may be accessed and executed by the one or more processors on the exemplary system 100 to perform some or all of the techniques described herein. Similarly, application specific integrated circuits (ASICs) configured to perform some or all of the processes described herein may be included in the one or more processors on the exemplary system 100.

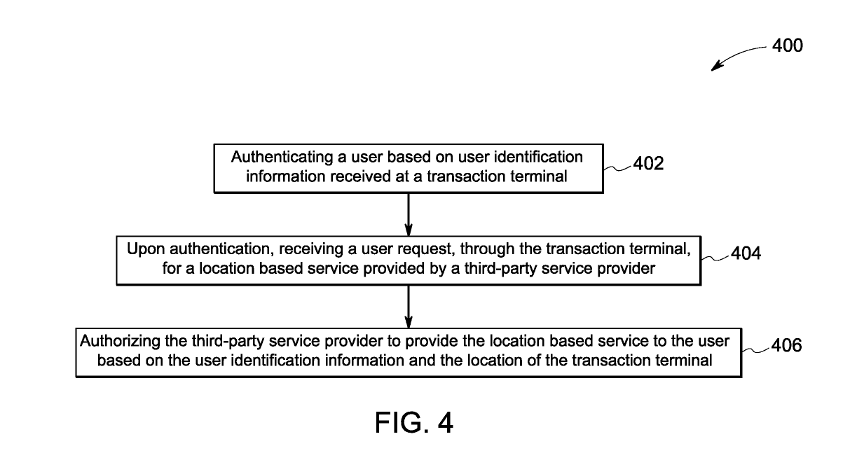

For example, referring now to FIG. 4, exemplary control logic 400 for obtaining location based services provided by third-party service providers through the transaction terminal via a system, such as the exemplary system 100, is depicted via a flowchart in accordance with some embodiments. As illustrated in the flowchart, the control logic 400 includes the step of authenticating a user based on user identification information received at the transaction terminal at step 402. Upon authentication, the control logic 400 further includes the step of receiving a user request, through the transaction terminal, for a location based service provided by a third-party service provider at step 404. The control logic 400 further includes the step of authorizing the third-party service provider to provide the location based service to the user based on the user identification information and the location of the transaction terminal at step 406.

It should be noted that, in some embodiments, the user identification information may be received through a portable transaction device associated with the user. As stated above, the portable transaction device may include, but is not limited to one of a smart card, a transaction card, a RFID card, a transaction token, and a payment card. Thus, the user identification information may be received by reading information from the portable transaction device through a portable transaction device reader integrated with the transaction terminal. Alternatively, in some embodiments, the user identification information may be directly inputted by the user at the transaction terminal. Further, it should be noted that, in some embodiments, the user may be registered for one or more location based services from one or more third-party service providers. In such embodiments, the user may pre-register for the one or more location based services from the one or more third-party service providers by associating the portable transaction device with the one or more location based services. The registration may be facilitated by one of: a payment processing entity, or a transaction authorizing entity. Further, it should be noted that, in some embodiments, the authentication may be performed by the transaction authorizing entity.

In some embodiments, the control logic 400 may include the step of rendering to the user, through the transaction terminal, a list of available location based services and associated one or more third-party service providers based on the user identification information and the location of the transaction terminal. Additionally, in some embodiments, the control logic 400 may include the step of providing the user identification information and the location of the transaction terminal to the third-party service provider. It should be noted that, in such embodiments, the user identification information and the location of the transaction terminal may be communicated to the third-party service provider by at least one of the transaction terminal, the payment processing entity, and the transaction authorizing entity.

In some embodiments, the control logic 400 may include the step of maintaining a third-party service database comprising mapping of registered third-party service providers to each of location based services, registered users, and registered transaction terminals with associated locations. In such embodiments, the control logic 400 may further include the step of accessing the third-party service database to determine one or more location based services available from one or more third-party service providers at the location of the transaction terminal for the user. It should be noted that the third-party service database may be maintained by one of: the payment processing entity, or the transaction authorizing entity.

In some embodiments, the control logic 400 may include the step of rendering service details to the user for availing the location based service through the transaction terminal. It should be noted that, the service details may be received from the third-party service provider based on the user identification information and the location of the transaction terminal. Further, the service details may include at least one of a service identification code, a service authorization code, a service delivery schedule, and a service delivery personnel identification. Additionally, it should be noted that, in such embodiments, the service details may be received from the third-party service provider through a payment processing entity or through a transaction authorizing entity. Moreover, in such embodiments, rendering the service details includes one of printing a receipt comprising information associated with the service details, or encoding the information associated with the service details onto a portable transaction device of the user. In some embodiments, the service details of a location based service provided by a third-party service provider may be encoded in a computer-readable medium of the portable transaction device. Further, in some embodiments, the service details encoded in the portable transaction device may be employed to authorize fulfillment of the location based service availed by the user.

In some embodiments, the control logic 400 may include the step of automatically charging a user account associated with the user for availing the location based service. In such embodiments, the charging may be based on an account balance in the user account or based on a line of credit extended to the user. Further, the third-party service provider may receive a payment for the location based service from one of: the payment processing entity, or the transaction authorizing entity.

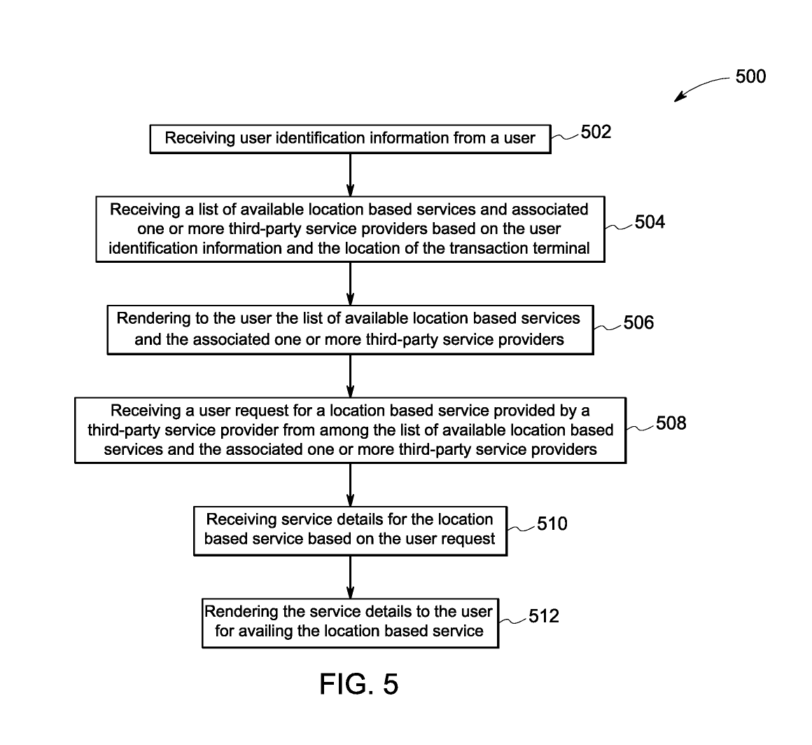

Referring now to FIG. 5, another exemplary control logic 500 for obtaining location based services provided by third-party service providers through the transaction terminal is depicted via a flowchart in accordance with some embodiments. As illustrated in the flowchart, the control logic 500 includes the steps of receiving user identification information from a user at step 502, receiving a list of available location based services and associated one or more third-party service providers based on the user identification information and the location of the transaction terminal at step 504, rendering to the user the list of available location based services and the associated one or more third-party service providers at step 506, receiving a user request for a location based service provided by a third-party service provider from among the list of available location based services and the associated one or more third-party service providers at step 508, receiving service details for the location based service based on the user request at step 510, and rendering the service details to the user for availing the location based service at step 512.

In some embodiments, the control logic 500 may further include the step of sending the user identification information for authentication. The authentication may be performed by one of the transaction authorizing entity, the payment processing entity, or the third-party service provider. In some embodiments, the control logic 500 may receive the list of available location based services and associated one or more third-party service providers at step 504 upon authentication of the user. Further, it should be noted that, the control logic 500 may receive the list of available location based services and associated one or more third-party service providers at step 504 from one of the transaction authorizing entity, the payment processing entity, or the third-party service provider.

In some embodiments, the control logic 500 may further include the step of sending the user request for the location based service provided by the third-party service provider for authorization. The authorization may be performed by one of the transaction authorizing entity, the payment processing entity, or the third-party service provider. In some embodiments, the control logic 500 may receive the service details for the location based service at step 510 upon authorization of the requested service. Further, it should be noted that, the control logic 500 may receive the service details for the location based service at step 510 from one of the transaction authorizing entity, the payment processing entity, or the third-party service provider.

As noted above, rendering the service details at step 512 includes one of printing a receipt comprising information associated with the service details, or encoding the information associated with the service details onto a portable transaction device of the user. In some embodiments, the service details may be encoded in a computer-readable medium of the portable transaction device, and may be employed to authorize fulfillment of the location based service availed by the user.

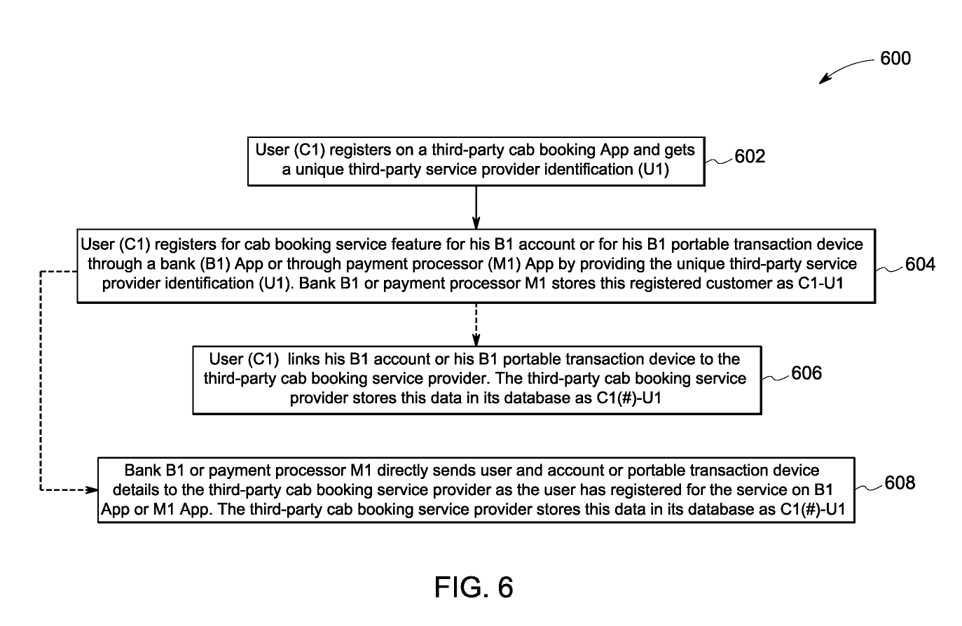

Referring now to FIG. 6, an exemplary control logic 600 for performing registration for obtaining location based cab booking service provided by a third-party service provider through the transaction terminal is depicted via a flowchart in accordance with some embodiments. As illustrated in the flowchart, at step 602, the user (C1) may register for a cab booking service provided by a third-party service provider (e.g., UBER®, OLA®, etc.) using a website or a mobile application of the third-party service provider. The user (C1) may be provided with a unique third-party service provider identification (U1). Further, at step 604, the user (C1) may register with a bank (B1) or a payment processor (M1) for cab booking service provided by the third-party service provider through a website or a mobile application of the bank (B1) or the payment processor (M1) by providing the unique third-party service provider identification (U1). The bank (B1) or the payment processor (M1) may store the registered user with a unique identification (C1-U1). At step 606, the user (C1) may link a user account or a portable transaction device identification (e.g., transaction card number) of the bank (B1) or the payment processor (M1) with a user account of the third-party service provider using its website or mobile application. Alternatively, at step 608, the bank (B1) or the payment processor (M1) directly sends the user account details or the portable transaction device details to the third-party service provider as the user (C1) has already registered for the cab booking service of the third-party service provider on the website or the mobile application of the bank (B1) or the payment processor (M1). The third-party service provider may now store the registered user in its database with a unique identification (C1(#)-U1).

Upon registration with one or more third-party service providers, the user (C1) may book a location based cab service through any of the one or more third-party service providers through a transaction terminal using the user account or the portable transaction device. As described in reference to FIG. 2, the cab booking process may involve different communication scenarios based on the entities involved in facilitating cab booking service through the transaction terminal.

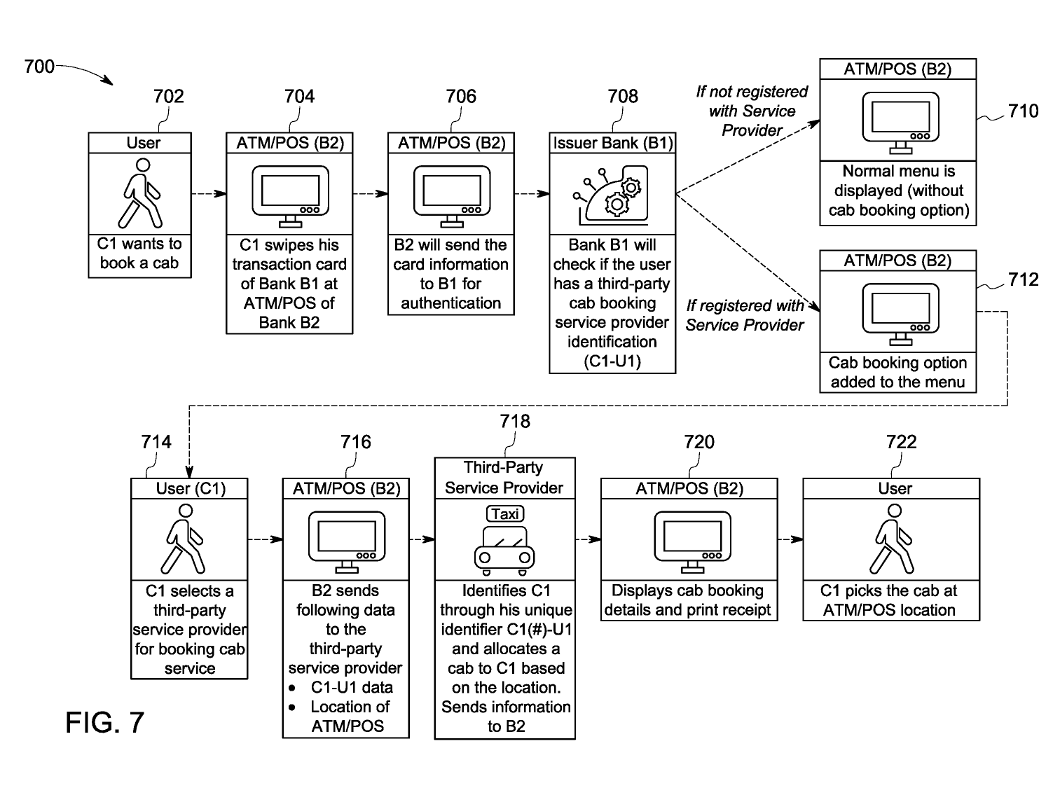

For example, referring now to FIG. 7, an exemplary information flow 700 between various entities during a cab booking process through the transaction terminal is illustrated, in accordance with some embodiments. In the illustrated embodiment, the information flow between the transaction terminal and the third-party service provider is managed directly by the transaction terminal through the acquirer bank (B2). At step 702, the user (C1) desiring to book a cab walks to a transaction terminal (e.g., ATM, PoS device, etc.) operated by a bank (B2). At step 704, the user (C1) interacts with the transaction terminal of the bank (B2) either directly or using his portable transaction device (e.g., transaction card, payment card, etc.) of bank (B1). For example, in some embodiments, the user (C1) may swipe his transaction card of the bank (B1) at an ATM or a PoS device operated by the bank (B2). At step 706, the bank (B2) sends the identification information received from the user (C1) (e.g., transaction card information) to the bank (B1) for authentication. At step 708, the bank (B1) authenticates the user, and determines if the user is registered for the cab booking services by one or more third-party service providers. Thus, the bank (B1) determines if the user has one or more third-party cab booking service providers identification (C1-U1, C1-U2, etc.). If the user is not registered with any of the service providers, then at step 710, the transaction terminal of bank (B2) renders a standard menu (i.e., without cab booking option). For example, the transaction terminal of bank (B2) displays a standard user interface or provides a standard interactive voice response (IVR) menu. However, if the user is registered with one or more of the service providers, then at step 712, the transaction terminal of bank (B2) displays a full-service menu (i.e., with cab booking option from the one or more service providers added to the standard menu).

At step 714, the user (C1) selects a third-party service provider from among the one or more service providers for booking cab service rendered by the transaction terminal. At step 716, the bank (B2) forwards the user request to the selected third-party service provider. The bank (B2) sends the third-party service provider identification (e.g., C1-U1) as well as the location of the transaction terminal to the selected third-party service provider. At step 718, the selected third-party service provider identifies the user (C1) through his unique identifier (C1(#)-U1) based on the identification (C1-U1) received from the bank (B2), and determines a cab nearest to the location of the transaction terminal. The third-party service provider then allocates the nearest cab to the user (C1) and sends the service details to the bank (B2). At step 720, the transaction terminal renders the service details (i.e., cab booking details) to the user (C1). Additionally, the user (C1) may print a receipt comprising of the cab booking details through the transaction terminal. Alternatively, in some embodiments, the cab booking details may be encoded in the portable transaction device (e.g., transaction card) of the user. At step 722, the user (C1) picks up the cab at the location of the transaction terminal. The user (C1) may further authorize the ride using the booking details received at the transaction terminal.

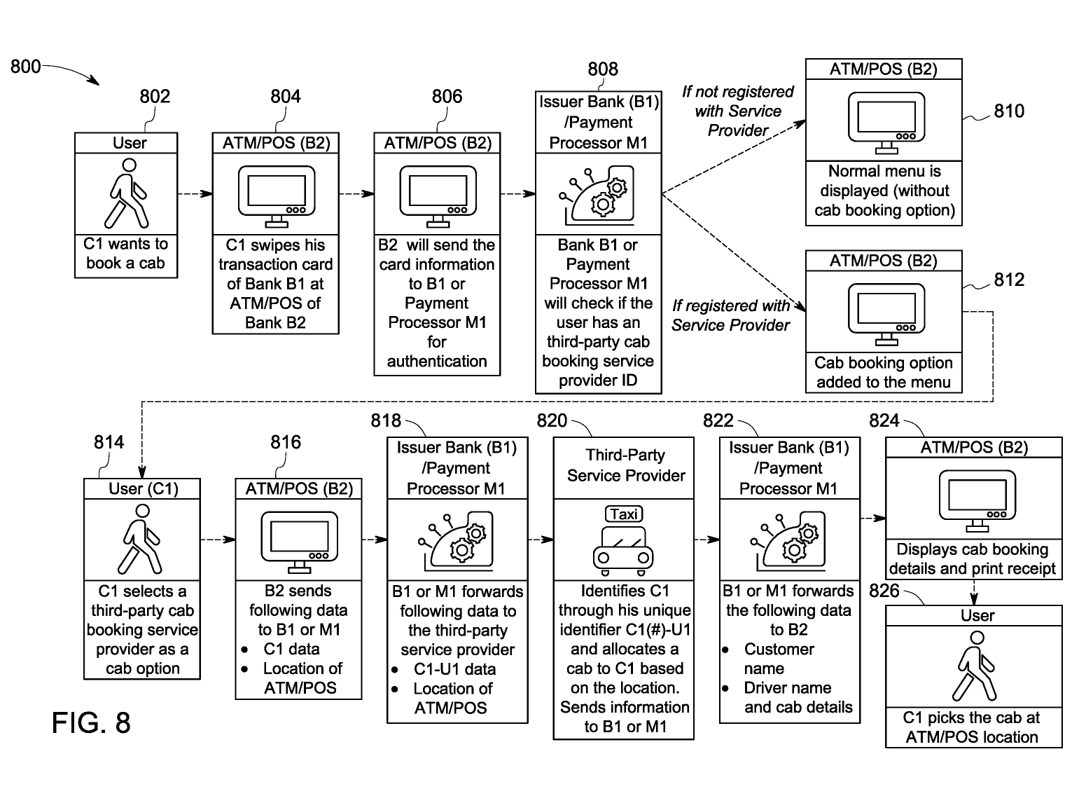

Referring now to FIG. 8, another exemplary information flow 800 between various entities during a cab booking process through the transaction terminal is illustrated, in accordance with some embodiments. In the illustrated embodiment, the information flow between the transaction terminal and the third-party service provider is managed by the issuer bank (B1) or the intermediary payment processing entity (M1). At step 802, the user (C1) desiring to book a cab walks to a transaction terminal (e.g., ATM, PoS device, etc.) operated by a bank (B2). At step 804, the user (C1) swipes transaction card of the bank (B1) at the transaction terminal of the bank (B2). At step 806, the bank (B2) sends the acquired transaction card information to the bank (B1) for authentication. At step 808, the bank (B1) authenticates the user, and determines if the user is registered for the cab booking services by one or more third-party service providers. If the user is not registered with any of the service providers, then at step 810, the transaction terminal of bank (B2) renders a standard menu (i.e., without cab booking option). However, if the user is registered with one or more of the service providers, then at step 812, the transaction terminal of bank (B2) displays a full-service menu (i.e., with cab booking option from the one or more service providers added to the standard menu).

At step 814, the user (C1) selects a third-party service provider from among the one or more service providers for booking cab service rendered by the transaction terminal. At step 816, the bank (B2) forwards the user request to the bank (B1) or the payment processing entity (M1) for processing the user request. The bank (B2) sends the user identification (e.g., U1) as well as the location of the transaction terminal to the bank (B1) or the payment processing entity (M1). At step 818, the bank (B1) or the payment processing entity (M1) determines the third-party service provider identification (e.g., C1-U1) and forwards the user request to the selected third-party service provider. The bank (B1) or the payment processing entity (M1) sends the third-party service provider identification (e.g., C1-U1) and the location of the transaction terminal to the selected third-party service provider. At step 820, the selected third-party service provider identifies the user (C1) through his unique identifier (C1(#)-U1) based on the identification (C1-U1) received from the bank (B1) or the payment processing entity (M1), and determines a cab nearest to the location of the transaction terminal. The third-party service provider then allocates the nearest cab to the user (C1) and sends the information to the bank (B1) or the payment processing entity (M1). At step 822, the bank (B1) or the payment processing entity (M1) forwards the service details (i.e., cab booking details) to the bank (B2). The service details may include, but are not limited to, a trip number, a customer name, a driver name, a cab registration number, a cab identification details, a cab arrival schedule, a trip authorization code, and an estimated fare.

At step 824, the transaction terminal renders the service details to the user (C1). As discussed above, the user (C1) may print a receipt comprising of the service details through the transaction terminal. Alternatively, in some embodiments, the service details may be encoded in the transaction card of the user. At step 826, the user (C1) picks up the cab at the location of the transaction terminal. The user (C1) may further authorize the ride using the trip authorization code. Alternatively, in some embodiments, the encoded service details may be employed to authorize the ride using the transaction card.

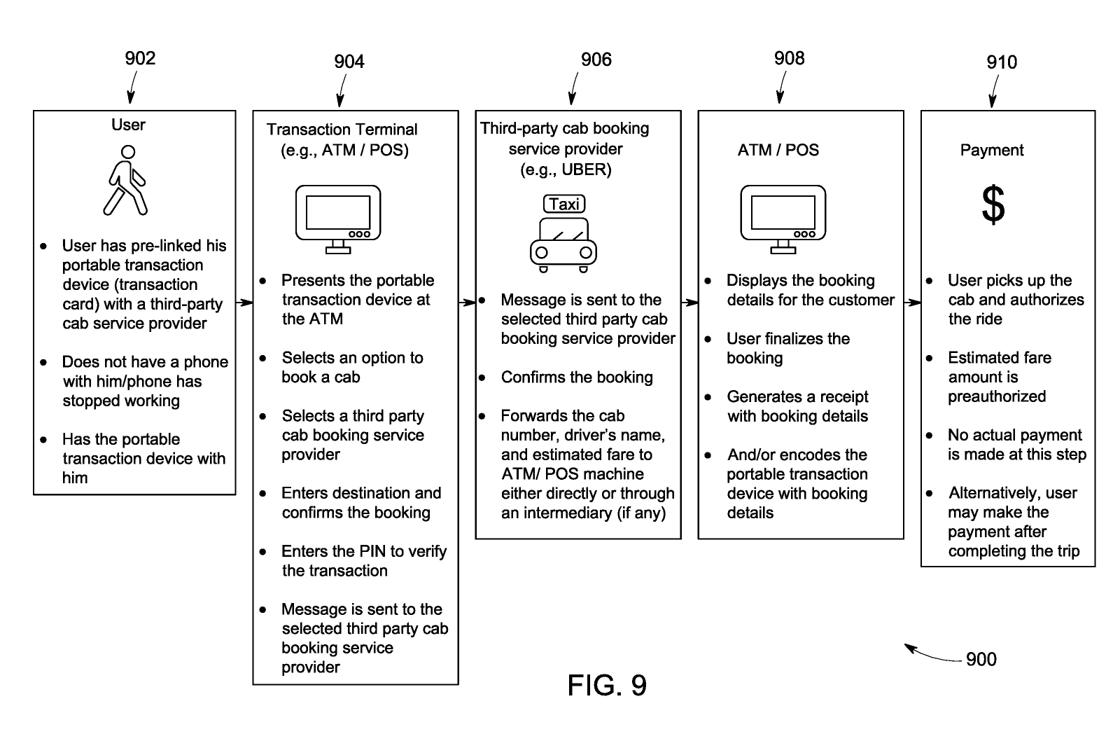

Referring now to FIG. 9, an exemplary cab booking process 900 through the transaction terminal is illustrated, in accordance with some embodiments. A user has registered himself for cab booking service provided by one or more service providers, and pre-linked his transaction account or the portable transaction device (e.g., transaction card) with his account with the one or more third-party service providers. In a certain situation, at step 902, the user desires to book a cab but does not have his smart mobile device (device unavailable or non-functional). However, the user has his transaction account details or has the portable transaction device. The user therefore walks to a transaction terminal (e.g., ATM, PoS device, etc.). At step 904, the user provides his authentication details either directly or through his portable transaction device. Since the user is registered for cab booking services, the transaction terminal presents the user with an option to book a cab through the one or more third-party service providers. The user selects a third-party service provider from among the one or more of the third-party service providers for booking a cab. In some embodiments, the user may also enter the destination before confirming the booking. In some embodiments, the user may be requested to confirm and authenticate the transaction by using authentication details (e.g., PIN), or otherwise through an affirmative action if the authentication details had already been supplied. The transaction terminal hen sends the user request (along with user identification and the location of the transaction terminal) to the selected third-party service provider either directly or through one or more transaction authentication, processing, and authorizing entities.

At step 906, the third-party service provider determines an available cab in the vicinity of the transaction terminal based on the location of the transaction terminal. Upon availability, the third-party service provider conforms the booking, and forwards the service details (i.e., cab booking details) to the transaction terminal either directly or through one or more transaction authentication, processing, and authorizing entities. The service details may include at least one of a cab number, a driver name, a trip authorization code, and an estimated fare. At step 908, the transaction terminal renders (e.g., displays, prints, announce, etc.) the service details to the user. The user finalizes the booking. In some embodiments, the transaction terminal generates a receipt with the service details. Alternatively, in some embodiments, the transaction terminal encodes the service details in the portable transaction device. At step 910, the user picks up the cab at the location of the transaction terminal and authorizes the ride using a trip authorization code or with the portable transaction device having encoded service details. In some embodiments, the estimated fare based on the entered destination is pre-authorized and therefore payment does not need to be made to the cab driver. Alternatively, in some embodiments, the user may make the payment after completing the trip and only a service charge may be charged to the user account.

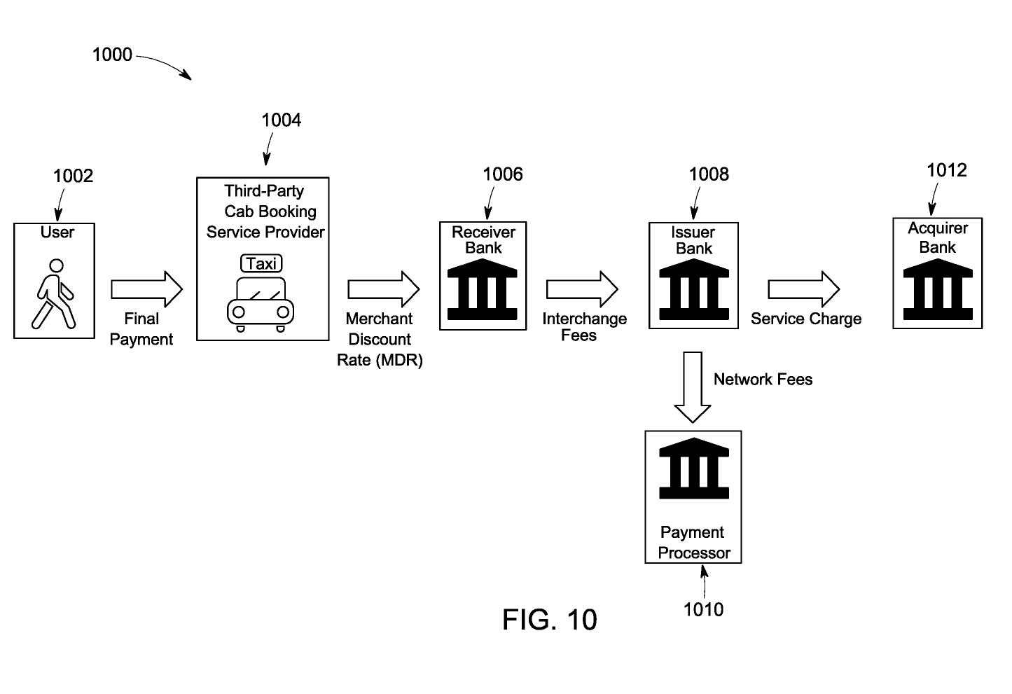

Referring now to FIG. 10, an exemplary payment processing 1000 for location based cab service availed by the user through the transaction terminal is illustrated, in accordance with some embodiments. As illustrated, a user 1002 may make a final payment to a third-party cab service provider 1004. The final payment may be in the form of a pre-paid fare (i.e., an estimated fare paid by the user at the time of booking the service), a fare paid after availing the service based on an estimated fare pre-authorized by the user at the time of booking the service, or a fare paid by the user to the driver and a pre-decided service fee paid by the user for availing the service. The pre-paid fare, the pre-authorized estimated fare, or the pre-decided service fee may be received directly by a receiver bank 1006. As will be appreciated, the receiver bank 1006 may be the bank of the service provider. The third-party cab service provider 1004 may therefore pass a Merchant Discount Rate (MDR) to the receiver bank 1006 for receiving the payment made by the user on behalf of the third-party service provider. The receiver bank 1006 may pass an interchange fees to an issuer bank 1008, which in turn may pass a network use fees to a payment processing entity 1010. The issuer bank 1008 may further pass a service charge to an acquirer bank 1012. The acquirer bank 1012 may be a bank operating the ATM through which the user made the booking or a merchant's bank account linked to the PoS machine through which the user made the booking.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

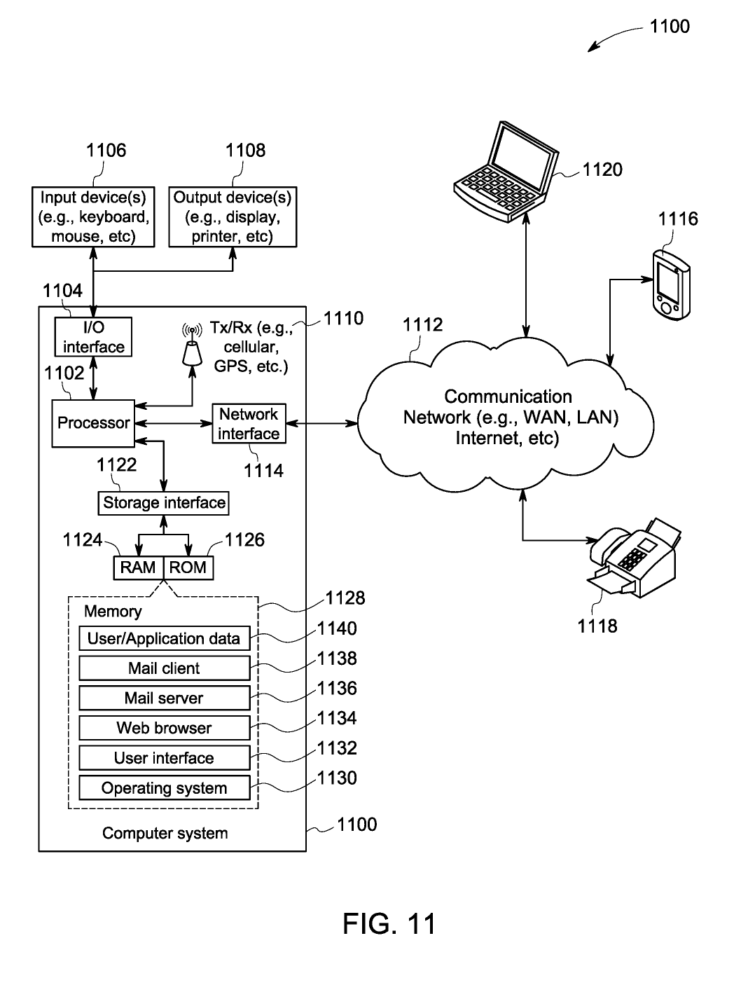

The disclosed methods and systems may be implemented on a conventional or a general-purpose computer system, such as a personal computer (PC) or server computer. Referring now to FIG. 11, a block diagram of an exemplary computer system 1100 for implementing embodiments consistent with the present disclosure is illustrated. Variations of computer system 1100 may be used for implementing system 100 for facilitating booking of third-party location based services through the transaction terminal. Computer system 1100 may include a central processing unit (“CPU” or “processor”) 1102. Processor 1102 may include at least one data processor for executing program components for executing user-generated or system-generated requests. A user may include a person, a person using a device such as such as those included in this disclosure, or such a device itself. Processor 1102 may include specialized processing units such as integrated system (bus) controllers, memory management control units, floating point units, graphics processing units, digital signal processing units, etc. Processor 1102 may include a microprocessor, such as AMD Athlon, Duron or Opteron, ARM's application, embedded or secure processors, IBM PowerPC, Intel's Core, Itanium, Xeon, Celeron or other line of processors, etc. Processor 1102 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 1102 may be disposed in communication with one or more input/output (I/O) devices via an I/O interface 1104. I/O interface 1104 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 1104, computer system 1100 may communicate with one or more I/O devices. For example, an input device 1106 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 1108 may be a printer, fax machine, video display (e.g., cathode ray tube (CRT), liquid crystal display (LCD), light-emitting diode (LED), plasma, or the like), audio speaker, etc. In some embodiments, a transceiver 1110 may be disposed in connection with processor 1102. Transceiver 1110 may facilitate various types of wireless transmission or reception. For example, transceiver 1110 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 1102 may be disposed in communication with a communication network 1112 via a network interface 1114. Network interface 1114 may communicate with communication network 1112. Network interface 1114 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 1112 may include, without limitation, a direct interconnection, local area network (LAN), wide area network (WAN), wireless network (e.g., using Wireless Application Protocol), the Internet, etc. Using network interface 1114 and communication network 1112, computer system 1100 may communicate with devices 1116, 1118, and 1120. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 1100 may itself embody one or more of these devices.

In some embodiments, processor 1102 may be disposed in communication with one or more memory devices (e.g., a RAM 1124, a ROM 1126, etc.) via a storage interface 1122. Storage interface 1122 may connect to memory devices 1128 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 1128 may store a collection of program or database components, including, without limitation, an operating system 1130, a user interface application 1132, a web browser 1134, a mail server 1136, a mail client 1138, a user/application data 1140 (e.g., any data variables or data records discussed in this disclosure), etc. Operating system 1130 may facilitate resource management and operation of computer system 1100. Examples of operating system 1130 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 1132 may facilitate display, execution, interaction, manipulation, or operation of program components through textual or graphical facilities. For example, user interfaces may provide computer interaction interface elements on a display system operatively connected to computer system 1100, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 1100 may implement web browser 1134 stored program component. Web browser 1134 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 1100 may implement mail server 1136 stored program component. Mail server 1136 may be an Internet mail server such as Microsoft Exchange, or the like. Mail server 1136 may utilize facilities such as ASP, ActiveX, ANSI C++/C#, Microsoft .NET, CGI scripts, Java, JavaScript, PERL, PHP, Python, WebObjects, etc. Mail server 1136 may utilize communication protocols such as internet message access protocol (IMAP), messaging application programming interface (MAPI), Microsoft Exchange, post office protocol (POP), simple mail transfer protocol (SMTP), or the like. In some embodiments, computer system 1100 may implement mail client 1138 stored program component. Mail client 1138 may be a mail viewing application, such as Apple Mail, Microsoft Entourage, Microsoft Outlook, Mozilla Thunderbird, etc.

In some embodiments, computer system 1300 may store user/application data 1140, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above facilitate booking of third-party location based services using transaction terminals (i.e, ATMs, or PoS devices). The techniques described in the various embodiments discussed above employ existing network of ATMs and Merchant POS to act as a booking device for the users in case of emergencies. Thus, the end users will have convenience to avail third-party location based services even when the users' smart mobile devices is not available or not functional. The issuer bank or the payment processing entity offering such solutions will be benefitted by higher card spend, better brand image, as well as through nominal service fees for providing such services. The bank operating the transaction terminal may earn revenue by way of commission on booking of such location based services. The third-party service provider will be benefitted as current unserved segment may have access to their services, thereby increasing their revenue.

The specification has described apparatus and method for obtaining location based services provided by third-party service providers through a transaction terminal. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

1. A method for obtaining location based services provided by third-party service providers through a transaction terminal, the method comprising:
authenticating a user based on user identification information received at the transaction terminal;
upon authentication, receiving a user request, through the transaction terminal, for a location based service provided by a third-party service provider; and
authorizing the third-party service provider to provide the location based service to the user based on the user identification information and the location of the transaction terminal.

2. The method of claim 1, wherein the user identification information is received through a portable transaction device associated with the user, the portable transaction device comprising one of a smart card, a transaction card, a RFID card, a transaction token, and a payment card.

3. The method of claim 2, wherein the user identification information is received by reading portable transaction device information from the portable transaction device through a portable transaction device reader integrated with the transaction terminal.

4. The method of claim 1, wherein the user is registered for one or more location based services from one or more third-party service providers.

5. The method of claim 1, further comprising rendering to the user, through the transaction terminal, a list of available location based services and associated one or more third-party service providers based on the user identification information and the location of the transaction terminal.

6. The method of claim 1, further comprising providing the user identification information and the location of the transaction terminal to the third-party service provider.

7. The method of claim 6, wherein the user identification information and the location of the transaction terminal is communicated to the third-party service provider by at least one of the transaction terminal, a payment processing entity, and a transaction authorizing entity.

8. The method of claim 1, further comprising maintaining a third-party service database comprising mapping of registered third-party service providers to each of location based services, registered users, the portable transaction devices, and registered transaction terminals with associated locations.

9. The method of claim 8, further comprising accessing the third-party service database to determine one or more location based services available from one or more third-party service providers at the location of the transaction terminal for the user.

10. The method of claim 1, further comprising rendering service details to the user for availing the location based service through the transaction terminal, wherein the service details are received from the third-party service provider based on the user identification information and the location of the transaction terminal.

11. The method of claim 10, wherein the service details are received from the third-party service provider through a payment processing entity or through a transaction authorizing entity.

12. The method of claim 10, wherein the service details include at least one of a service identification code, a service authorization code, a service delivery schedule, and a service delivery personnel identification.

13. The method of claim 10, wherein rendering the service details comprises one of:
printing a receipt comprising information associated with the service details; or
encoding the information associated with the service details onto the portable transaction device of the user.

14. The method of claim 1, further comprising automatically charging a user account or the portable transaction device associated with the user for availing the location based service.

15. A transaction terminal, comprising:
an input device;
an output device;
a network device; and
at least one processor for executing instructions so as to perform operations comprising:
receiving, through the input device, user identification information from a user;
receiving, through the network device, a list of available location based services and associated one or more third-party service providers based on the user identification information and the location of the transaction terminal;
rendering, through the output device, to the user the list of available location based services and the associated one or more third-party service providers;
receiving, through the input device, a user request for a location based service provided by a third-party service provider from among the list of available location based services and the associated one or more third-party service providers;
receiving, through the network device, service details for the location based service based on the user request; and
rendering, through the output device, the service details to the user for availing the location based service.

16. The transaction terminal of claim 15, wherein the transaction terminal comprises a geo-positioning device for determining the location.

17. The transaction terminal of claim 15, wherein rendering the service details comprises one of:
printing a receipt comprising information associated with the service details; or
encoding the information associated with the service details onto a portable transaction device of the user.

18. The transaction terminal of claim 15, further comprising sending the user identification information for authentication, wherein the authentication is performed by one of a transaction authorizing entity, a payment processing entity, or the third-party service provider, and wherein the list of available location based services and associated one or more third-party service providers is received from one of the transaction authorizing entity, the payment processing entity, or the third-party service provider upon authentication of the user.

19. The transaction terminal of claim 15, further comprising sending the user request for authorization, wherein the authorization is performed by one of a transaction authorizing entity, a payment processing entity, or the third-party service provider, and wherein the service details are received from one of the transaction authorizing entity, the payment processing entity, or the third-party service provider upon authorization of the requested service.

20. An automated teller machine (ATM), comprising:
an input device comprising at least one of a card reader, a touch screen, and a keypad;
an output device comprising at least one of a display device and a printer;
a network device configured to communicate with at least one of a cab service provider, a transaction authorizing entity, and a payment processing entity; and
at least one processor for executing instructions so as to perform operations comprising:
receiving, through the input device, user identification information from a user;
sending, through the network device, the user identification information for authentication of the user, wherein the authentication is performed by one of the transaction authorizing entity, the payment processing entity, or the cab service provider;
upon authentication of the user, receiving, through the network device, a list of available location based cab services from the cab service provider based on the user identification information and the location of the transaction terminal from one of the transaction authorizing entity, the payment processing entity, or the cab service provider;
rendering, through the output device, to the user the list of available location based cab services from the cab service provider;
receiving, through the input device, a user request for a location based cab service provided by the cab service provider from among the list of available location based cab services from the cab service provider;
sending, through the network device, the user request for authorization, wherein the authorization is performed by one of the transaction authorizing entity, the payment processing entity, or the cab service provider;
upon authorization of the requested service, receiving, through the network device, service details for the location based service based on the user request from one of the transaction authorizing entity, the payment processing entity, or the cab service provider; and
rendering, through the output device, the service details to the user for availing the location based cab service, wherein rendering comprises at least one of displaying information associated with the service details, and printing a receipt comprising information associated with the service details.
